(19) United States
(12) Patent Application Publication
(10) Pub. No.: US 2012/0063462 A1
(43) Pub. Date: Mar. 15, 2012

(54) METHOD, APPARATUS AND SYSTEM FOR FORWARDING VIDEO DATA

(75) Inventors: Yinliang Hu, Nanjing (CN); Hewen Zheng, Nanjing (CN); Xiaojun Yan, Nanjing (CN); Wenxiao Yu, Shenzhen (CN)

(73) Assignee: Huawei Technologies Co., Ltd., Shenzhen (CN)

(21) Appl. No.: 13/300,214

(22) Filed: Nov. 18, 2011

Related U.S. Application Data
(63) Continuation of application No. PCT/CN2010/072350, filed on Apr. 30, 2010.

(30) Foreign Application Priority Data
May 22, 2009 (CN) 200910107617.2

(51) Int. Cl. H04L 12/56

(52) U.S. Cl. 370/394

(57) ABSTRACT

The present disclosure relates to the field of video transmission, and discloses a method, an apparatus, and a system for forwarding video data. A network device receives and buffers a media stream, resolves the buffered media stream, obtains Transport Stream (TS) packets in the media stream, and evaluates and identifies a visual sensitivity priority of each TS packet; discards a TS packet of low visual sensitivity, and re-capsulates a TS packet of high visual sensitivity into a new media stream; and sends the re-encapsulated new media stream to a user equipment. The network device is enabled to discard the TS packet of low visual sensitivity in the media stream, which reduces duration of a fast channel change.

### CROSS-REFERENCE TO RELATED APPLICATIONS

This application is a continuation of International Application No. PCT/CN2010/072350, filed on Apr. 30, 2010, which claims priority to Chinese Patent Application No. 200910107617.2, filed with the Chinese Patent Office on May 22, 2009, both of which are hereby incorporated by reference in their entireties.

### FIELD

The present disclosure relates to video communications technologies in network communications technologies, and in particular, to a method, an apparatus, and a system for forwarding video data.

### BACKGROUND

An Internet Protocol Television (IPTV) is a new technology that uses a broadband cable television network, integrates multiple technologies such as the Internet, multimedia and communication, and is capable of providing a user with multiple interactive services including a digital television service. A linchpin of an IPTV system is a fast channel change. In an existing IPTV system, channel changing delay is long, which severely affects Quality of Experience (QoE) of a user. Multiple factors affect IPTV channel changing delay, including: time consumed for quitting a multicast group of an old channel, time consumed for joining a multicast group of a new channel, time consumed for filling a de-jitter buffer of a user terminal such as a Set Top Box (STB), time consumed for waiting for a decodable I frame of the new channel, and so on. The time consumed for waiting for an I frame of the new channel is an essential part to the delay.

Currently, MPEG-2 and H.264 coding standards are generally used for video compression in the IPTV system. A television picture is encoded into Group of Pictures (GOP) that includes an I frame, some P frames, and some B frames. The I frame is called an internal coding frame, also known as a key frame, and can be decoded and displayed independently; the P frame is called a forward prediction frame, and is generated as a result of prediction based on the P frame or I frame prior to the P frame, and cannot be decoded or displayed independently; the B frame is also known as a bidirectional interpolation frame, and is generated as a result of prediction based on a frame prior to the B frame and a frame next to the B frame, and cannot be decoded or displayed independently. Because the P frame and the B frame employ an inter-frame reference coding algorithm that does not need to encode a whole video picture, the P frame and the B frame provide higher coding efficiency than the I frame. In a broadcast television operation, to obtain a higher compression ratio, in an applied coding sequence, a gap between I frames is generally about 0.55 second. In this way, the quantity of the P frames or the B frames is much larger than the quantity of the I frames in a formed coding sequence. When a user changes a channel, the user encounters a P frame or a B frame in most cases. At this time, if a network device directly pushes a media stream to the user terminal (such as STB) starting from the P frame or B frame, the user terminal has to discard the received P frame or B frame and starts decoding only after a next I frame is received, because the P frame or the B frame can be decoded only based on a previous I frame.

To solve a problem of a long channel changing delay that is caused by waiting for the I frame, in the prior art, when receiving a channel changing request from the user, the network device obtains a media stream that starts from the I frame in a buffer, and quickly pushes the media stream to the user terminal, which reduces the delay of the user terminal waiting for the I frame and quickens the channel changing. The specific steps are as follows:

(1) The network device buffers a media stream corresponding to each IPTV channel in real time;

(2) At the time of changing a channel, the user terminal requests a media stream of the new channel from the network device;

(3) The network device quickly pushes, starting from the I frame, a buffered media stream of the new channel to the user terminal in a unicast mode;

(4) The user terminal starts to decode and play a video of the new channel after receiving a complete I frame;

(5) The user terminal requests for joining the multicast group corresponding to the new channel, and receives a real-time multicast media stream after joining the multicast group; and

(6) When discovering that a media stream obtained from the network device coincides with a real-time multicast media stream, the user terminal stops obtaining a unicast media stream from the network device.

However, when the GOP of a live programming of IPTV is long (such as 4-8 seconds), that is, when the gap between the I frames is long, traffic of a burst media stream that needs to be quickly pushed by the network device is large when the user terminal requests channel changing. In an extreme circumstance, a buffered media stream of 1-7 seconds needs to be quickly pushed to the user terminal. In this case, as the amount of data of the burst stream is large, a high requirement is imposed on a buffer of the user terminal; a medium-end or low-end user terminal may lose a message due to buffer overflow, which affects picture quality; meanwhile, a high requirement is imposed on a transport bandwidth. Moreover, the push of the burst stream takes a long time; if the push is performed on a bandwidth-limited line, a packet loss caused by the long-time quick push consumes extra retransmission time and bandwidth, which increases a load on a server.

Moreover, with rapid development of a triple-play service, especially enrichment of a video service, a requirement on network bandwidth constantly increases, and the existing network bandwidth can hardly meet a user requirement. Therefore, network congestion occurs inevitably. When network congestion occurs, a random discard mechanism is generally applied in the prior art. When a buffer queue of the network device is fully occupied, a newly arrived data packet is discarded regardless of a priority of data that is transmitted. For the video service, if some important data is discarded randomly, a picture suffers problems such as a mosaic and a jitter, which severely affects the QoE of the user and is unacceptable to the user.

In conclusion, in a process of video transmission, it is necessary to selectively discard some video data without on the prerequisite that the QoE of the user is not affected, so as to reduce the changing delay, improve the transmission efficiency and relieve the network load.

### SUMMARY

Embodiments of the present disclosure provide a method, an apparatus, and a system for forwarding video data to reduce a changing delay and relieve a network load in a process of transmitting a video.

According to one aspect of the present disclosure, a method for forwarding video data is provided. The method includes: receiving and buffering, in a processor, a media stream, resolving the buffered media stream, obtaining Transport Stream (TS) packets in the media stream, and evaluating and identifying a visual sensitivity priority of each TS packet; discarding a TS packet of low visual sensitivity, and re-encapsulating a TS packet of high visual sensitivity into a new media stream; and sending the re-encapsulated new media stream to a user equipment, where the TS packet of high visual sensitivity includes at least a video TS packet that encapsulates an internal coding frame.

According to another aspect of the present disclosure, an apparatus for forwarding video data is provided. The apparatus includes: a receiving module, configured to receive a media stream; a buffering module configured to buffer the media stream received by the receiving module; a first processing module configured to instruct a processor to resolve the media stream buffered by the buffering module, obtain TS packets in the media stream, and evaluate and identify a visual sensitivity priority of each TS packet; a second processing module configured to instruct the processor to discard a TS packet of low visual sensitivity and re-encapsulate a TS packet of high visual sensitivity into a new media stream according to evaluation of the first processing module; and a first sending module configured to send the new media stream re-encapsulated by the second processing module to a user equipment, where the TS packet of high visual sensitivity includes at least a video TS packet that encapsulates an internal coding frame.

According to another aspect of the present disclosure, a system for forwarding video data is provided. The system includes at least the apparatus for forwarding video data.

According to another aspect of the present disclosure, a method for evaluating a visual sensitivity priority of TS packets, including: receiving and buffering, in a processor, a media stream, and recognizing video TS packets from the buffered media stream; determining a GOP that needs to be disassembled according to the TS packets, and inversely disassembling the GOP to extract each video frame in the GOP according to a frame reference relation; determining a visual sensitivity priority of each video frame from low to high according to a disassembling order of each video frame; and evaluating and identifying, in a processor, a visual sensitivity priority of the video TS packets according to visual sensitivity priorities of the video frames that are encapsulated in the video TS packets.

Through implementation of the foregoing embodiments of the present disclosure, the network device discards a video TS packet of low visual sensitivity as required and re-encapsulates a TS packet of high visual sensitivity into a new media stream for transmitting, which reduces data traffic in the network and improves transmission efficiency on the prerequisite that QoE of a user is not affected.

### BRIEF DESCRIPTION OF THE DRAWINGS

To describe the embodiments of the present disclosure or in the prior art more clearly, the following briefly describes the accompanying drawings involved in description of the embodiments. Apparently, the accompanying drawings are only some exemplary embodiments of the present disclosure, and persons of ordinary skill in the art can derive other drawings from these accompanying drawings without any creative effort.

FIG. 1 is a schematic flowchart of a method for forwarding video data according to an embodiment of the present disclosure;

FIG. 2 is a schematic flowchart of a method for forwarding video data according to another embodiment of the present disclosure;

FIG. 3 is a schematic flowchart of a method for forwarding video data according to another embodiment of the present disclosure;

FIG. 4 is a schematic structural diagram of an apparatus for forwarding video data according to an embodiment of the present disclosure;

FIG. 5 is a schematic flowchart of a method for evaluating a visual sensitivity priority of a video frame according to an embodiment of the present disclosure; and

FIG. 6 is a schematic structural diagram of a frame in a GOP according to an embodiment of the present disclosure.

### DETAILED DESCRIPTION OF THE EMBODIMENTS

The embodiments of the present disclosure provide a method, an apparatus, and a system for forwarding video data, and are applied in the video transmission field to reduce data traffic in a network on the prerequisite that QoE of a user is not affected. As detailed implementation modes, the embodiments of the present disclosure are applied in video transmission that is encapsulated by using an MPEG-2 TS standard.

MPEG-2 TS is a standard that assembles a video stream, an audio stream and another basic data stream into one or multiple data streams suitable for storage or transmission. According to a difference in quality of transmission media, two different format specifications are defined in the MPEG-2: a TS and a Program Stream (PS). The TS differs from the PS in that a packet structure of the TS has a fixed length, but a packet structure of the PS has a variable length. Because the TS adopts a fixed-length packet structure, when synchronization information of a TS packet is damaged in the transmission, a receiving device may detect the synchronization information in a packet subsequent to this TS packet at a fixed location, and recover synchronization, which avoids an information loss. Moreover, because a fixed-length packet format is adopted, the TS provides sufficient flexibility for multiplexing of multiple channels of data, and features various merits such as dynamic bandwidth allocation, gradability, extensibility, and interference cancellation. Therefore, the TS is widely applied and becomes a universal standard in the media industry.

In a scenario of encapsulating a video stream based on MPEG-2 TS, as each IP message has 1500 bytes and each TS packet has only 188 bytes, each IP message is capable of carrying up to 7 TS packets. The 7 TS packets may include video packets of different load types (such as an I frame, a P frame, and a B frame), an audio packet, a Program Association Table (PAT), a Program Map Table (PMT), a filler packet, and so on. According to a load type of a TS packet, a transmission priority of the TS packet may be determined, and further, a transmission priority of an IP message may be determined. When the network device is congested or sends a unicast burst stream, selective discarding may be performed according to the priority of the IP message. However, when TS packets with different priorities are mixed in one IP message, the IP message cannot be discarded if a TS packet in the IP message has a high priority.

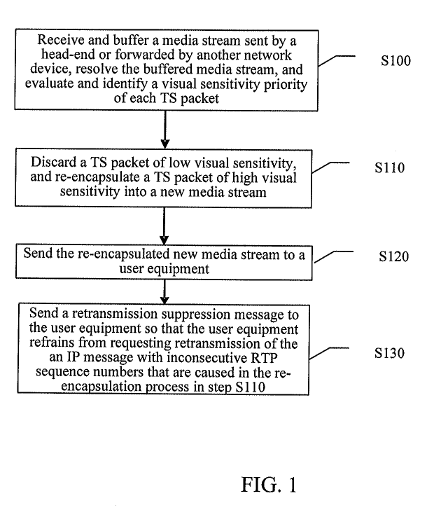

FIG. 1 is a schematic flowchart of a method for forwarding video data according to an embodiment of the present disclosure. The method includes the following steps:

S100: Receive and buffer a media stream sent by a head-end or forwarded by another network device. Resolve the buffered media stream, obtain TS packets in the media stream, and then evaluate and identify a visual sensitivity priority of each TS packet.

The media stream buffered in the foregoing process may be a multicast media stream or a unicast media stream.

It should be noted that in all TS packets of the media stream, both a TS packet that carries a video and a non-video TS packet that carries audio and other control information may be included. In this embodiment of the present disclosure, for ease of description, priorities of all TS packets are uniformly called visual sensitivity priorities, but it should be noted that all non-video TS packets are stipulated as having high visual sensitivity priorities and cannot be discarded. A video TS packet of high visual sensitivity has a high priority; and a video TS packet of low visual sensitivity has a low priority. Therefore, for brevity of description, in this application, for a video TS packet, high visual sensitivity is equivalent to a high visual sensitivity priority, and low visual sensitivity is equivalent to a low visual sensitivity priority. The high visual sensitivity and the low visual sensitivity in this application are relative concepts, and may be set or stipulated by a user according to a requirement on picture sharpness, a condition of network bandwidth occupation, and so on, which is not specified in this application.

S110: Discard a TS packet of low visual sensitivity in the buffered media stream to be sent, and re-encapsulate a TS packet of high visual sensitivity into a new media stream.

In this embodiment, the video TS packet of low visual sensitivity may be discarded according to a set percentage, a network congestion state, a channel description, a configuration parameter, or a set priority. The TS packet of high visual sensitivity includes at least a video TS packet that encapsulates an internal coding frame, and cannot be discarded. In addition, in this embodiment, a non-video TS packet may not be discarded.

In step S110, the new media stream may be a multicast media stream carried in the IP message, a unicast media stream of a channel, or a unicast burst stream of the channel (in the case of a fast channel change).

S120: Send the new media stream re-encapsulated in step S110 to a user equipment.

If the media stream buffered in step S100 is the media stream carried in the IP message, the process of re-encapsulating the TS packet in step S110 may be: discarding the TS packet of low visual sensitivity after resolving the IP message, and re-encapsulating an IP message header of this IP message and the TS packet of high visual sensitivity in the IP message into a new IP message (shorter than the original IP message but with the same sequence number); or, discarding the original message header and re-encapsulating a packet header for the TS packet that needs to be transmitted; or, reassembling several consecutive IP messages, whose payloads are less than 7 TS packets after the TS packet of low visual sensitivity is discarded, into a new IP message that carries the media stream, or directly discarding an IP message in which all TS packets have low visual sensitivity. In the latter two circumstances, Real-time Transfer Protocol (RTP) sequence numbers in the reassembled IP message may be inconsecutive. In this case, in order to prevent a retransmission request caused by a packet loss from impacting a network, this embodiment may further include:

S130: Send a retransmission suppression message to the user equipment to instruct the user equipment to refrain from requesting retransmission of an IP message with inconsecutive RTP sequence numbers that are caused in the re-encapsulation process in step S110.

In this embodiment of the present disclosure, the network device discards the TS packet of low visual sensitivity in the video packets, re-encapsulates the TS packet of high visual sensitivity into a media stream carried in the IP message, and sends the re-encapsulated media stream to the user equipment. In addition, through a retransmission suppression mechanism, the user equipment does not request retransmission of the IP message with inconsecutive RTP sequence numbers that are caused by the re-encapsulation. In this way, the transmission efficiency is improved, and the network bandwidth is saved.

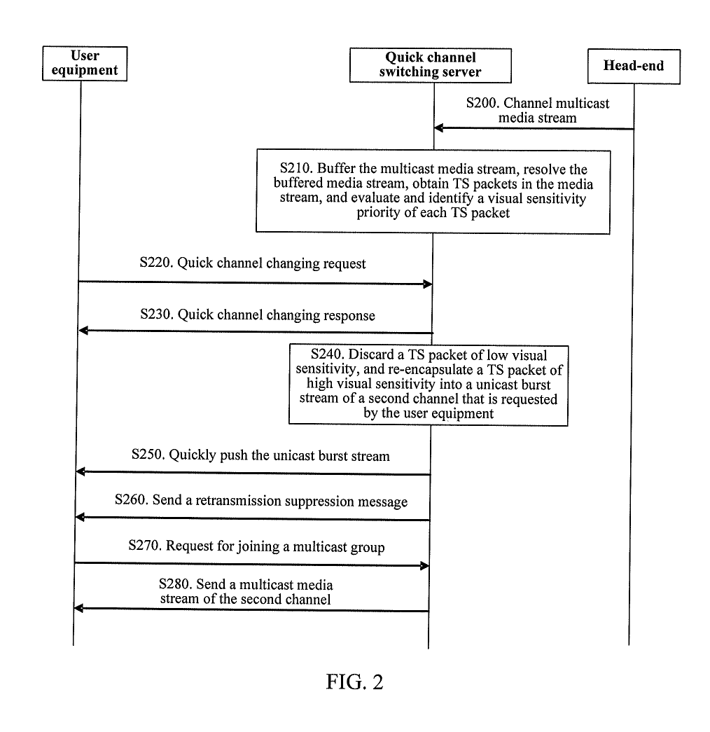

FIG. 2 is a schematic flowchart of a method for forwarding video data according to another embodiment of the present disclosure. The embodiment is applied in a fast channel change scenario, and includes the following steps:

S200: A head-end sends a channel multicast media stream to a fast channel change server.

As an implementation mode, the head-end may send channel multicast media streams of multiple channels. The channel multicast media stream is carried in an IP message. In this step, it may also be that another network device sends a channel multicast media stream to the fast channel change server.

S210: After receiving the channel multicast media stream, the fast channel change server buffers the corresponding multicast media stream, resolves the buffered media stream, obtains TS packets in the media stream, and evaluates and identifies a visual sensitivity priority of each TS packet.

If channel multicast media streams of multiple channels are received, the fast channel change server needs to separately store the multiple channel multicast media streams to prevent an error from occurring in transmitting a program.

Moreover, in this step, Program Specific Information (PSI) of each channel in the buffered media stream may be identified and stored. The PSI includes a PAT, a PMT, a Conditional Access Table (CAT), a Network Information Table (NIT), and so on.

S220: The fast channel change server receives a fast channel change request sent by the user equipment to request for changing from a first channel to a second channel.

S230: The fast channel change server sends a fast channel change response to the user equipment, and allows the user equipment to perform a fast channel change.

S240: The fast channel change server discards a TS packet of low visual sensitivity in a media stream corresponding to the second channel, and re-encapsulates a TS packet of high visual sensitivity into a new unicast burst stream of the second channel.

Although step S240 is performed after step S220 in this embodiment, the performing order is not limited in a practical application. That is, step S240 may be spontaneously performed by the fast channel change server, or the user equipment may send a fast channel change request to trigger the fast channel change server to perform step S240; or the fast channel change server performs 5240 according to a notification or request of adjusting a transmission rate that is sent by the user equipment.

S250: The fast channel change server quickly pushes the unicast burst stream to the user equipment.

In this embodiment of the present disclosure, when the fast channel change server quickly pushes the unicast burst stream to the user equipment, the push may start from an I frame or an IDR frame (corresponding to the H.264 standard) that can be decoded independently. However, a channel program encapsulated through MPEG2-TS can be demultiplexed and decoded only relying on the PSI. In this case, the PSI of the second channel needs to be pushed before the I frame or the IDR frame is pushed. Certainly, the push may also start from a first PAT packet before the I frame or the IDR frame.

In another embodiment, the PSI of the second channel that is buffered in step S210 may be pushed to the user equipment first in this step, and the push is continued starting from the I frame or the IDR frame that actually needs to be pushed. In this way, the user equipment can immediately decode and display the I frame or the IDR frame after receiving the I frame or the IDR frame, which reduces duration of the fast channel change. The pushed PSI may be a collection of multiple buffered distributed pieces of PSI of the second channel.

If the media stream is carried in the IP message, the re-encapsulating the TS packet of high visual sensitivity into the unicast burst stream in step S240 may be: discarding a TS packet of low visual sensitivity after resolving the IP message, reserving only a TS packet of high visual sensitivity in the IP message, and re-encapsulating an IP message header corresponding to the user equipment for this message; or, reassembling several consecutive IP messages, whose payloads are less than 7 TS packets after the TS packet of low visual sensitivity are discarded, into a new IP message, and re-encapsulating the IP message header corresponding to the user equipment for the new IP message. In the latter circumstance, RTP sequence numbers in the newly assembled IP message may be inconsecutive. In this case, in order to prevent a retransmission request caused by a packet loss from impacting a network, this embodiment may further include:

S260: The fast channel change server sends a retransmission suppression message to the user equipment, where the retransmission suppression message is configured to instruct the user equipment to refrain from requesting retransmission of the IP message with inconsecutive RTP sequence numbers that are caused in the re-encapsulation process in step S240.

S270: The user equipment sends a request for joining a multicast group of the second channel to the fast channel change server. Here, the request may be sent by the user equipment actively, or sent by the user equipment according to notification of the fast channel change server.

S280: When discovering that the unicast burst stream is synchronous to a multicast media stream of the second channel, the fast channel change server stops sending the unicast burst stream, and sends the multicast media stream of the second channel to the user equipment instead.

In this embodiment of the present disclosure, at the time of a fast channel change, the TS packet of low visual sensitivity is discarded selectively according to a load type of the TS packet, and the TS packet of high visual sensitivity are re-encapsulated into a media stream and sent to the user equipment. In this way, transmission time of the unicast burst stream is reduced at the time of the fast channel change, network congestion is avoided, a changing delay is reduced, and user experience is enhanced.

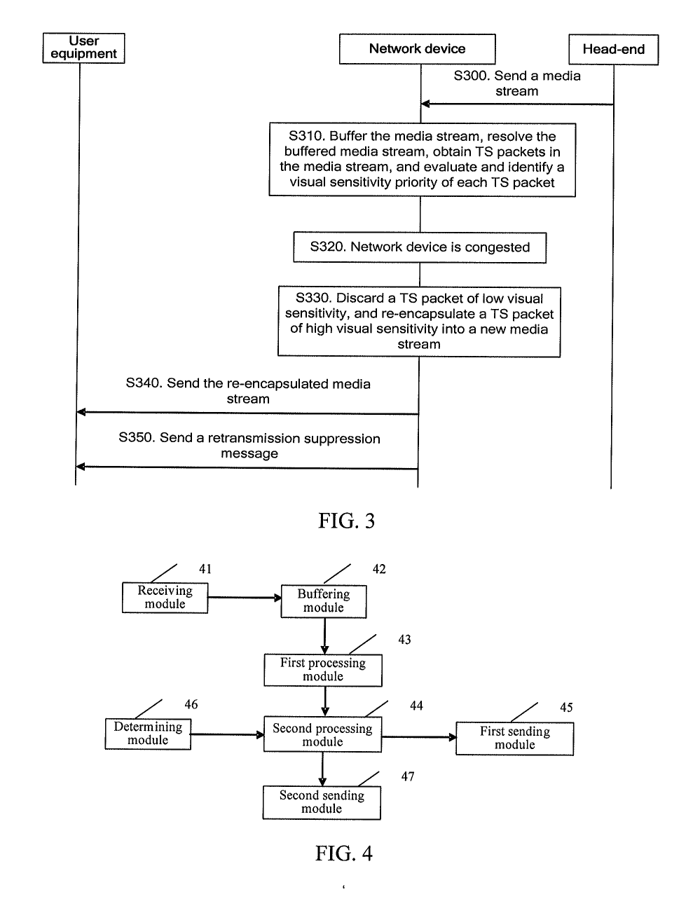

FIG. 3 is a schematic flowchart of a method for forwarding video data according to another embodiment of the present disclosure, which is primarily applied in a scenario where network congestion occurs. The method in this embodiment includes the following steps:

S300: A head-end sends a media stream to a network device.

In this step, it may also be that another network device sends a media stream to the network device, and the sent media stream may correspond to multiple channels or programs. The media stream may be carried in an IP message.

S310: After receiving and buffering the media stream, the network device resolves the buffered media stream, obtains TS packets in the media stream, and evaluates and identifies a visual sensitivity priority of each TS packet.

S320: The network device performs network congestion detection. Step S330 is performed if it is determined that network congestion occurs.

S330: According to the network congestion state, the network device discards a TS packet of low visual sensitivity in the media stream that needs to be sent, and re-encapsulates a TS packet of high visual sensitivity into a new media stream.

S340: The network device sends the re-encapsulated new media stream to the user equipment.

When the media stream is a unicast media stream carried in the IP message, the re-encapsulating the TS packet of high visual sensitivity into a new media stream in step S330 may be: discarding a TS packet of low visual sensitivity after resolving the IP message, and reserving only a TS packet of high visual sensitivity in the IP message; directly forwarding the IP message if all TS packets in the IP message have high visual sensitivity; directly discarding the IP message if all the TS packets in the IP message have low visual sensitivity; or, reassembling several consecutive IP messages, whose payloads are less than 7 TS packets after the TS packet of low visual sensitivity is discarded, into a new IP message. Due to the discarding or the assembling, RTP sequence numbers in the IP message may be inconsecutive. In order to prevent a retransmission request caused by the inconsecutive RTP sequence numbers from impacting a network, this embodiment may further include the following steps:

S350: The network device sends a retransmission suppression message to the user equipment so that the user equipment refrains from requesting retransmission of the IP message with inconsecutive RTP sequence numbers that are caused in the re-encapsulation process in step S330.

When the media stream is carried in the IP message and the media stream is a multicast media stream, the re-encapsulating the TS packet of high visual sensitivity into a new media stream in step S330 may specifically be: The network device encapsulates the TS packet of high visual sensitivity into a new media stream carried in the IP message, and the message header of the IP message carries corresponding information about the user equipment.

In this embodiment of the present disclosure, the network device selectively discards, according to the network congestion state, the TS packet of low visual sensitivity in the channel media stream that needs to be sent, re-encapsulates the TS packet of high visual sensitivity into an IP message, and sends the IP message to the user equipment. In addition, through a retransmission suppression message, the user equipment does not request retransmission of the IP message with inconsecutive RTP sequence numbers that are caused by IP message assembling. In this way, data traffic in the network is reduced, and the network congestion is relieved.

In the foregoing embodiments of the present disclosure, the amount of buffered data of each channel may be set according to the configuration. For example, a media stream capable of playing for 2 or 4 seconds is buffered. The media stream may include audio, a video, and other information that is included in the channel. Moreover, at the time of buffering media streams carried in IP messages, the IP messages need to be sorted according to the RTP sequence numbers to ensure that the IP messages are stored sequentially.

In the foregoing embodiments of the present disclosure, the retransmission suppression message may be a next IP message that carries retransmission suppression information and needs to be normally sent to the user equipment, or may be an extended RTP message or a Real-time Transfer Control Protocol (RTCP) message.

In the foregoing embodiments, after the buffered media stream is resolved and the TS packets in the media stream are obtained, the visual sensitivity priority of each TS packet is evaluated. This may be implemented by using a following method, including:

(1) In the buffered media stream, recognize PSI corresponding to the media stream, and store the PSI.

(2) In the buffered media stream, recognize a video TS packet and a non-video TS packet (for example, an audio TS packet and a TS packet that encapsulates other control information). Set the visual sensitivity of the non-video TS packet as a high priority so that the non-video TS packet cannot be discarded. For the video TS packet, mark the GOP and the beginning and the end of each frame (that is, a frame border). Specifically, recognize key video information such as a PAT, a PMT, and a frame beginning tag through Deep Packet Inspection (DPI); or identify special information by a video source (that is, the head-end), and recognize the key video information according to the special information at the time of buffering the media stream.

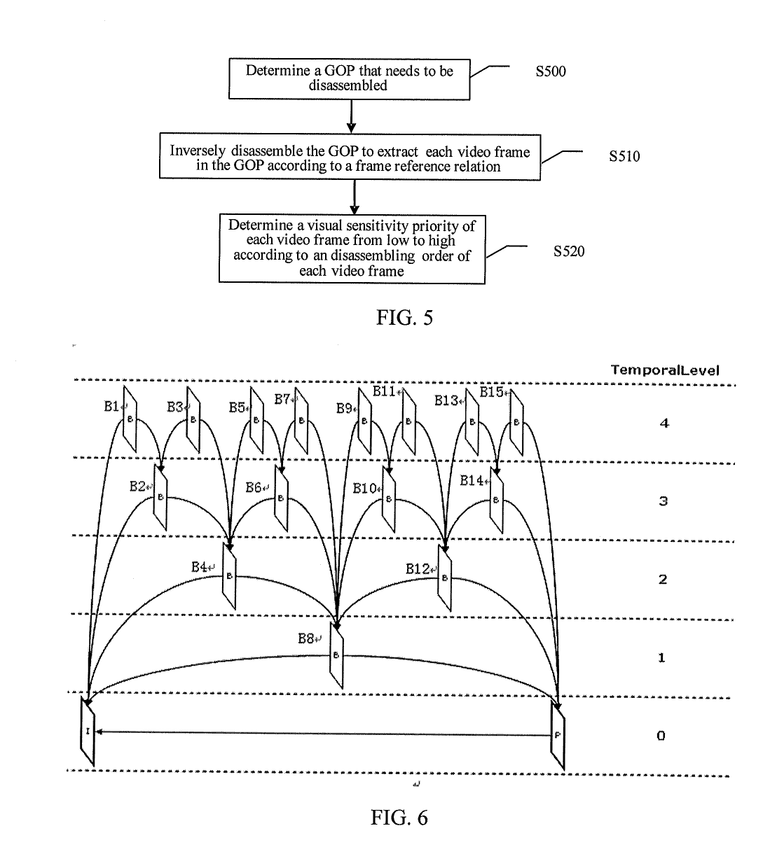

(3) Evaluate the visual sensitivity of each video frame. As shown in FIG. 5, a method for evaluating a visual sensitivity priority of a video frame includes:

S500: Determine a GOP that needs to be disassembled.

FIG. 6 is a schematic structural diagram of a frame in a GOP according to an embodiment of the present disclosure. For ease of description about a reference relation between frames, the GOP includes an I frame, a P frame (a forward prediction frame), and 15 B frames (bidirectional interpolation frames). Each B frame is generated as a result of prediction based on a frame prior to the B frame and a frame next to the B frame. For example, in FIG. 6, a B8 frame is generated as a result of prediction based on the I frame and the P frame. In a practical application, a GOP may include one I frame and multiple P frames. The B frame may have only one reference level, which, however, does not affect the application scope of the present disclosure.

In a GOP structure, a temporal level indicates the reference relation between frames. The top temporal level is a non-reference level. No frame on this level is referenced by another frame. For example, in FIG. 6, the B frames (including B1, B3, B5, B7, B9, B11, B13, and B15) on temporal level 4 are not referenced by another frame. Because these frames are not referenced by another frame, discarding of such a frame does not affect decoding or display of a remaining video frame sequence. Other levels are reference levels and all frames on these reference levels are referenced by another frame. For example, in FIG. 6, all frames (including I, P, B8, B4, B12, B2, B6, B10, and B14) on temporal level 0, temporal level 1, temporal level 2, and temporal level 3 are referenced by another frame. For example, B14 may be referenced by B13 and B15, and B10 may be referenced by B9 and B11. Because these frames are referenced by another frame, discarding of such a frame leads to a decoding error, a mosaic picture, and so on. However, if the another frame that references a specific frame is discarded, this specific frame becomes a non-reference frame, and the discarding of this frame does not affect the decoding or display of the remaining video frame sequence.

S510: Inversely disassemble the GOP to extract each video frame in the GOP according to a frame reference relation.

A specific disassembling method may include: (a) disassembling the GOP to extract video frames from the last video frame of a non-reference level to a reference level (from the end to the beginning), that is, starting from B15 in this embodiment; and (b) after completion of extracting all video frames that are generated by referencing a specific video frame, extracting this referenced video frame. In this embodiment, B15 and B13 are generated by referencing B14, and therefore, B14 is extracted after completion of extracting B15 and B13. After completion of extracting B14, continue to inversely disassembling the GOP to extract the video frames starting from the non-reference level until all video frames in the whole GOP are extracted.

According to this embodiment of the present disclosure, a disassembling order of each video frame in the GOP shown in FIG. 6 is B15, B13, B14, B11, B9, B10, B12, B7, B5, B6, B3, B1, B2, B4, B8, P, and I.

S520. Determine a visual sensitivity priority of each video frame from low to high according to the disassembling order of each video frame.

If it is set that a video frame extracted first has a low visual sensitivity priority and a video frame extracted later has a high visual sensitivity priority, in this embodiment of the present disclosure, the visual sensitivity priorities of the video frames shown in FIG. 6 are ranked from low to high as: B15, B13, B14, B11, B9, B10, B12, B7, B5, B6, B3, B1, B2, B4, B8, P, and I.

(4) Evaluate and identify the visual sensitivity priority of each TS packet according to the visual sensitivity priority of each video frame. When a TS packet includes only one video frame, the visual sensitivity priority of the TS packet is the visual sensitivity priority of the video frame; when the TS packet includes multiple video frames, the visual sensitivity priority of the TS packet is the visual sensitivity priority of a video frame that has the highest visual sensitivity priority and is included in the TS packet; when the TS packet includes an internal coding frame, the TS packet is identified as a high priority, and cannot be discarded.

Through the foregoing embodiment of the present disclosure, the visual sensitivity priority of each TS packet can be evaluated, and then the TS packets that may be discarded are determined according to a channel description feature, a configuration parameter, a network congestion state, a set packet loss ratio, and so on.

An embodiment of the present disclosure also discloses an apparatus for forwarding video data to implement the methods described in the foregoing embodiments of the present disclosure. As shown in FIG. 4, the apparatus in this embodiment of the present disclosure includes:

a receiving module 41, configured to receive a multicast stream sent by a head-end or forwarded by another network device (see steps S100, S200, and S300 for a specific implementation mode);

a buffering module 42, configured to buffer the multicast stream received by the receiving module 41 (see steps S100, S210, and S310 for specific embodiments); and

a first processing module 43, configured to resolve the media stream buffered by the buffering module 42, obtain TS packets in the media stream, and evaluate and identify a visual sensitivity priority of each TS packet (see steps S100, S210, and S310 for a specific implementation mode);

where the first processing module may further include: a first submodule, configured to distinguish a video TS packet among the TS packets, and evaluate and identify a visual sensitivity priority of the video TS packet; the first submodule specifically includes: a GOP determining module, configured to determine, in the media stream, a GOP that needs to be disassembled according to the video TS packet; a disassembling module, configured to inversely disassemble, according to a frame reference relation, the GOP determined by the GOP determining module to extract each video frame in the GOP; a first priority determining module, configured to determine a visual sensitivity priority of each extracted video frame according to an order of extracting the video frames by the disassembling module; and a second priority determining module, configured to determine a visual sensitivity priority of the video TS packet that encapsulates a video frame according to the visual sensitivity priority of each video frame determined by the first priority determining module;

a second processing module 44, configured to, according to the evaluation of the first processing module 43, discard a TS packet of low visual sensitivity and re-encapsulate a TS packet of high visual sensitivity into a new media stream (see steps S110, S240, and S330 for a specific implementation mode); and

a first sending module 45, configured to send the new media stream that is re-encapsulated by the second processing module 44 to a user equipment (see steps S120, S250, and S340 for a specific implementation mode).

The apparatus in this embodiment of the present disclosure may further include a determining module 46, configured to: determine whether network congestion occurs, and, when the network congestion occurs, trigger the second processing module 44 to discard the TS packet of low visual sensitivity and to re-encapsulate the TS packet of high visual sensitivity into a new multicast media stream or unicast media stream.

The receiving module 41 in the apparatus in this embodiment of the present disclosure is further configured to: receive a fast channel change request sent by the user equipment, and, according to the fast channel change request, trigger the second processing module 44 to discard the TS packet of low visual sensitivity and to re-encapsulate the TS packet of high visual sensitivity into a unicast burst stream corresponding to a channel that is requested by the user.

When the media stream buffered by the buffering module 42 is carried in an IP message, the re-encapsulating, by the second processing module 44, the TS packet of high visual sensitivity into a new media may be: after resolving the IP message, discarding a TS packet of low visual sensitivity and reserving only a TS packet of high visual sensitivity in the IP message; or, reassembling several consecutive IP messages, whose payloads are less than 7 TS packets after the TS packet of low visual sensitivity is discarded, into a new IP message. In the latter circumstance, RTP sequence numbers in the newly assembled IP message may be inconsecutive. In order to prevent a retransmission request caused by a packet loss from impacting a network, the apparatus in this embodiment may further include:

a second sending module 47, configured to send a retransmission suppression message to the user equipment so that the user equipment refrains from requesting retransmission of the IP message with inconsecutive RTP sequence numbers that are caused in the re-encapsulation process performed by the second processing module (see steps S130, S260, and S350 for a specific implementation mode).

The apparatus for forwarding video data in this embodiment of the present disclosure may be a fast channel change server or a network device that needs to handle network congestion. The disclosed apparatus has a processor configured to implement the disclosed methods. If the apparatus for forwarding video data is the fast channel change server, the apparatus may further include a third processing module, configured to resolve the media stream buffered in the buffering module, obtain and store PSI, where the PSI is sent by the first sending module 45 to the user equipment before the unicast burst stream requested by the user equipment in a process of a fast channel change.

An embodiment of the present disclosure also provides a system for forwarding video data. The system includes the apparatus for forwarding video data shown in FIG. 4 and a user equipment. The system is configured to implement the methods described in all the foregoing method embodiments of the present disclosure. See the foregoing method embodiments for a specific implementation mode, and no further description is provided here.

Through implementing the foregoing embodiments of the present disclosure, the network device is enabled to discard the TS packet of low visual sensitivity in the media stream, which reduces duration of a fast channel change, relieves network congestion, and improves transmission efficiency without affecting the QoE of a user.

Through the description of the foregoing embodiments, those skilled in the art may be clearly aware that the present disclosure may be implemented through hardware, or through software in addition to a necessary universal hardware platform. Therefore, the solutions of the present disclosure may be embodied in a software product. The software product may be stored in a nonvolatile storage medium, such as a Compact Disk-Read Only Memory (CD-ROM), a Universal Serial Bus (USB) flash disk, and a mobile hard disk, and may incorporate several instructions that enable a computer device (such as a person al computer, a server, or a network device) having a processor to execute the methods provided in each embodiment of the present disclosure.

Although the disclosure is described through some exemplary embodiments, it should be noted that the disclosure is not limited to such embodiments. It is apparent that those of ordinary skill in the art can make modifications and variations to the disclosure without departing from the idea and scope of the disclosure. The disclosure is intended to cover the modifications and variations provided that they fall within the protection scope defined by the following claims or their equivalents.

What is claimed is:

1. A method for forwarding video data, comprising:
receiving and buffering, in a processor, a media stream, resolving the buffered media stream, obtaining Transport Stream (TS) packets in the media stream, and evaluating and identifying a visual sensitivity priority of each TS packet;
discarding a TS packet of low visual sensitivity, and re-encapsulating a TS packet of high visual sensitivity into a new media stream; and
sending the re-encapsulated new media stream to a user equipment, wherein
the TS packet of high visual sensitivity comprises at least a video TS packet that encapsulates an internal coding frame.

2. The method according to claim 1, wherein before the obtaining the TS packets in the media stream, the method further comprises obtaining Program Specific Information (PSI) from the buffered media stream and storing the PSI.

3. The method according to claim 2, wherein before discarding the TS packet of low visual sensitivity, the method further comprises:
receiving a fast channel change request from the user equipment for changing from a first channel to a second channel.

4. The method according to claim 3, wherein the re-encapsulated new media stream is specifically a unicast burst stream, which is carried in an Internet Protocol (IP) message, of the second channel; and
the sending the re-encapsulated new media stream to the user equipment is specifically sending the unicast burst stream of the second channel to the user equipment.

5. The method according to claim 4, wherein before sending the unicast burst stream of the second channel to the user equipment, the method further comprises: sending the stored PSI of the second channel to the user equipment.

6. The method according to claim 1, wherein if the media stream is carried in the IP message, the discarding the TS packet of low visual sensitivity and re-encapsulating the TS packet of high visual sensitivity into the new media stream specifically comprises:
in TS packets that are obtained after the IP message is resolved, discarding the TS packet of low visual sensitivity and re-encapsulating the TS packet of high visual sensitivity into a new IP message that carries the media stream

7. The method according to claim 1, wherein if the media stream is carried in the IP message, the discarding the TS packet of low visual sensitivity and re-encapsulating the TS packet of high visual sensitivity into the new media stream specifically comprises:
in TS packets that are obtained after the IP message is resolved, discarding the TS packet of low visual sensitivity, and reassembling multiple consecutive IP messages, whose payloads are less than 7 TS packets after the TS packet of low visual sensitivity is discarded, into an IP message that carries the media stream.

8. The method according to claim 1, further comprising:
sending a retransmission suppression message to the user equipment so that the user equipment refrains from requesting retransmission of an IP message with h inconsecutive Real-time Transport Protocol (RTP) sequence numbers that are caused in the re-encapsulation process.

9. A method for evaluating a visual sensitivity priority of a Transport Stream (TS) packet, comprising:
receiving and buffering, in a processor, a media stream, and recognizing a video TS packet in the buffered media stream;
determining, according to the TS packet, a Group of Pictures (GOP) that needs to be disassembled, and inversely disassembling the GOP to extract each video frame in the GOP according to a frame reference relation;
determining a visual sensitivity priority of each video frame from low to high according to a disassembling order of each video frame; and
evaluating and identifying, in the processor, a visual sensitivity priority of the video TS packet according to a visual sensitivity priority of a video frame that is encapsulated in the video TS packet.

10. The method according to claim 9, wherein the inversely disassembling the GOP to extract each video frame in the GOP according to the frame reference relation specifically comprises:
disassembling the GOP to extract the video frames from a last video frame of a non-reference level to a reference level; after completion of extracting all video frames that are generated by referencing a video frame, extracting this referenced video frame; and continuing the disassembly until all video frames in the whole GOP are extracted.

11. The method according to claim 9, wherein the determining the visual sensitivity priority of the video TS packet according to the video frame that is encapsulated in the video TS packet comprises:
if the video TS packet comprises only one video frame, the visual sensitivity priority of the TS packet is the visual sensitivity priority of the video frame; and
if the video TS packet comprises multiple video frames, the visual sensitivity priority of the TS packet is the visual sensitivity priority of a video frame which has the highest visual sensitivity priority among the multiple video frames.

12. An apparatus for forwarding video data, comprising:
a receiving module, configured to receive a media stream;
a buffering module, configured to buffer the media stream received by the receiving module;
a first processing module, configured to instruct a processor to resolve the media stream buffered by the buffering module, obtain Transport Stream (TS) packets in the media stream, and evaluate and identify a visual sensitivity priority of each TS packet;
a second processing module, configured to instruct the processor to discard a TS packet of low visual sensitivity and re-encapsulate a TS packet of high visual sensitivity into a new media stream according to the evaluation of the first processing module; and
a first sending module, configured to send the new media stream re-encapsulated by the second processing module to a user equipment, wherein
the TS packet of high visual sensitivity comprises at least a video TS packet that encapsulates an internal coding frame.

13. The apparatus according to claim 12, further comprising:
a third processing module, configured to instruct the processor to resolve the media stream buffered by the buffering module, and obtain and store Program Specific Information (PSI).

14. The apparatus according to claim 13, wherein:
the receiving module is further configured to: receive a fast channel change request sent by the user equipment, and, according to the fast channel change request, trigger the second processing module to discard the TS packet of low visual sensitivity and re-encapsulate the TS packet of high visual sensitivity into a unicast burst stream corresponding to a channel that is requested by the user equipment; and
the sending module is specifically configured to send the PSI to the user equipment before the unicast burst stream.

15. The apparatus according to claim 11, wherein the first processing module comprises:
a first submodule, configured to distinguish a video TS packet among the TS packets, and evaluate and identify a visual sensitivity priority of the video TS packet.

16. The apparatus according to claim 15, wherein the first submodule specifically comprises:
a GOP determining module, configured to determine a Group of Pictures (GOP) that needs to be disassembled in the media stream;
a disassembling module, configured to inversely disassemble, according to a frame reference relation, the GOP determined by the GOP determining module to extract each video frame in the GOP;
a first priority determining module, configured to determine a visual sensitivity priority of each extracted video frame according to an order of extracting the video frames by the disassembling module; and
a second priority determining module, configured to determine a visual sensitivity priority of a TS packet that encapsulates a video frame according to the visual sensitivity priority of each video frame determined by the first priority determining module.

17. The apparatus according to claim 12, wherein when the media stream is carried in an Internet Protocol (IP) message, the discarding the TS packet of low visual sensitivity and re-encapsulating the TS packet of high visual sensitivity into the new media stream specifically comprises:
in TS packets that are obtained after the IP message is resolved, discarding the TS packet of low visual sensitivity, and re-encapsulating the TS packet of high visual sensitivity and an original IP message header into a new IP message that carries the media stream.

18. The apparatus according to claim 12, wherein the discarding the TS packet of low visual sensitivity and re-encapsulating the TS packet of high visual sensitivity into a new media stream specifically comprises:
in TS packets that are obtained after the IP message is resolved, discarding the TS packet of low visual sensitivity, and reassembling multiple consecutive IP messages, whose payloads are less than 7 TS packets after the TS packet of low visual sensitivity is discarded, into a new IP message that carries the media stream.

19. The apparatus according to claim 12, further comprising:
a second sending module, configured to send a retransmission suppression message to the user equipment so that the user equipment refrains from requesting retransmission of an IP message with inconsecutive Real-time Transport Protocol (RTP) sequence numbers that are caused in the re-encapsulation process performed by the second processing module.
